(19) United States
(12) Patent Application Publication
(10) Pub. No.: US 2020/0216973 A1
(43) Pub. Date: Jul. 9, 2020

(54) WELDING BEAD CLEANING DEVICE WITH AUTOMATIC ELECTROLYTE REPLENISHMENT

(71) Applicant: Bosjob Company Limited, Jiangmen (CN)

(72) Inventors: Liang-huan WENG, Jiangmen (CN); Min-hsiang WENG, Jiangmen (CN)

(21) Appl. No.: 16/737,830

(22) Filed: Jan. 8, 2020

Related U.S. Application Data
(63) Continuation of application No. PCT/CN2017/113681, filed on Nov. 30, 2017.

(30) Foreign Application Priority Data
Jul. 19, 2017 (CN) 201710589830.6

(51) Int. Cl. C25F 1/04; C25F 7/00; B23K 9/26

(52) U.S. Cl. CPC C25F 1/04; B23K 9/26; C25F 7/00

(57) ABSTRACT

The present disclosure relates to a welding bead cleaning device with automatic electrolyte replenishment, comprising a host and a cleaning gun, wherein the host comprises a power module, the power module is provided with a power output wire and a ground wire, the cleaning gun is provided with a conductive gun head connected to the power output wire, and a front end of the conductive gun head is provided with flexible structure for absorbing an electrolyte for cleaning a welding bead, wherein the welding bead cleaning device further comprises an electrolyte replenishing device and an electronic control system. In use, the electronic control system drives the electric water pump and water valve to quantitatively deliver the electrolyte to the cleaning gun, so that the flexible structure on the gun can automatically replenish the electrolyte, which eliminates the repeated manual picking action, makes the operation more consistent and improves production efficiency.

### CROSS-REFERENCE TO RELATED APPLICATIONS

This application is a continuation of International Patent Application No. PCT/CN2017/113681, filed on Nov. 30, 2017, which claims the benefit of priority from Chinese Patent Application No. 201710589830.6, filed on Jul. 19, 2017. The contents of the aforementioned application, including any intervening amendments thereto, are incorporated herein by reference in its entirety

### TECHNICAL FIELD

The present disclosure relates to the field of welding, in particular to a welding bead cleaning device with automatic electrolyte replenishment.

### BACKGROUND

Metal welding is an indispensable process in the industrial field. Common welding processes usually use arc welding such as argon arc welding and gas shielded welding. During the welding process, there is a conversion process in which the metal is heated to a liquid state and finally cooled to a solid state. Although gas protection or flux protection is used in the welding process, oxidation inevitably occurs in the process of solidification after heating, which makes the welding bead appear black and unclean. In addition to poor appearance, the workpiece is easier to continue to rust and oxidize. Therefore, for some high-demanding workpiece, the welding bead cleaning process must be performed. There are two general cleaning methods. One cleaning method is grinding, in which various types of grinding machines are used to remove the oxide layer by friction using belts and wheels. The other cleaning method is using a special welding bead cleaning device as shown in FIG. 1. The welding bead cleaning device generally comprises a DC power supply 1, a cleaning gun 2, and a ground wire 3. After the metal workpiece 4 to be cleaned is fixed by the ground wire clip 5 at the end of the ground wire 3, the gun head 6 of the cleaning gun 2 is generally coated by absorbent cloth or absorbent cotton to cover the copper head, or a carbon brush which is capable of both conductivity and water absorption is used. Therefore, it is easy to pick up the electrolyte. Under the direct current power supply, the cleaning gun head 6 contacts the workpiece 4 to form an electrolytic circuit. This oxidation-reduction process can make the oxidized metal on the workpiece into the ionic state and enter the electrolyte, making the oxide adhered to the metal surface fall off. However, for traditional welding bead cleaning devices, the electrolyte cannot be automatically replenished for the gun tip. Electrolytic cleaning must be performed by repeatedly picking up the electrolyte with the gun tip. The operation is cumbersome and inefficient. Further, a bottle of electrolyte should be placed aside when cleaning, and the liquid is easily knocked over and pollutes the surrounding environment.

### SUMMARY

The present disclosure aims to solve the problem that for the existing welding bead cleaning device, the electrolyte must be repeatedly picked up with the gun tip to perform electrolytic cleaning, and proposes a welding bead cleaning device with automatic electrolyte replenishment, which can eliminate the need to repeatedly pick up the electrolyte and thus improve production efficiency.

The technical solution adopted by the present disclosure to solve its technical problems is:

A welding bead cleaning device with automatic electrolyte replenishment, comprising a host and a cleaning gun, wherein the host comprises a power module, the power module is provided with a power output wire and a ground wire, the cleaning gun is provided with a conductive gun head connected to the power output wire, and a front end of the conductive gun head is provided with flexible structure for absorbing an electrolyte for cleaning a welding bead, and wherein the host further comprises an electrolyte replenishing device and an electronic control system;

The electrolyte replenishing device comprises a storage container for storing an electrolyte and an electric water pump, the storage container is connected to the conductive gun head through an infusion tube, and the infusion tube is connected to the electric water pump; and

The electronic control system is connected to a power module and an electric water pump, respectively, and the electronic control system automatically controls the welding bead cleaning device to transmit electricity and deliver electrolyte through the power module and the electric water pump.

Preferably, the cleaning gun is provided with a control switch which is connected to the electronic control system, and when the control switch is triggered, the electronic control system automatically controls the power supply module and the electric water pump to transmit electricity and deliver electrolyte, respectively. Specifically, the control switch is provided at a hand gripping part of the cleaning gun, which is convenient for an operator to control the control switch with one hand when holding the cleaning gun and thus is convenient to use. The setting of the control switch enables a manual control function of the cleaning gun, which is convenient for the operator to control according to actual situation.

Preferably, the infusion tube is further provided with a water valve which is connected to the electronic control system, and the electronic control system controls an opening degree of the water valve. Delivery of electrolyte and flow rate can be controlled by the water valve.

Preferably, the electronic control system is provided with a control panel. Preferably, the control panel is provided with a power setting key and a flow rate setting key, which is convenient for power and flow rate preset by an operator.

Preferably, the conductive gun head and the flexible structure are carbon brushes. Preferably, the conductive gun head is a copper head, and the flexible structure is an absorbent cloth or cotton coated on the copper head.

Preferably, a front end of the ground wire is provided with a connection structure for fixing on a workpiece to be cleaned. Particularly, the connection structure is a ground wire clip.

The beneficial effect of the present disclosure is: compared with the prior art, the present disclosure proposes a welding bead cleaning device with automatic electrolyte replenishment, the welding bead cleaning device is provided with a cleaning gun, a storage container for containing the electrolyte, an electric water pump, a water valve and an electronic control system. In use, the electronic control system drives the electric water pump and water valve to quantitatively deliver the electrolyte to the cleaning gun, so that the flexible structure on the gun can automatically replenish the electrolyte, which eliminates the repeated manual picking action, makes the operation more consistent and improves production efficiency.

### BRIEF DESCRIPTION OF THE DRAWINGS

The present disclosure is further described below with reference to the drawings and embodiments.

FIG. 1 is a schematic view of a conventional welding bead cleaning device;

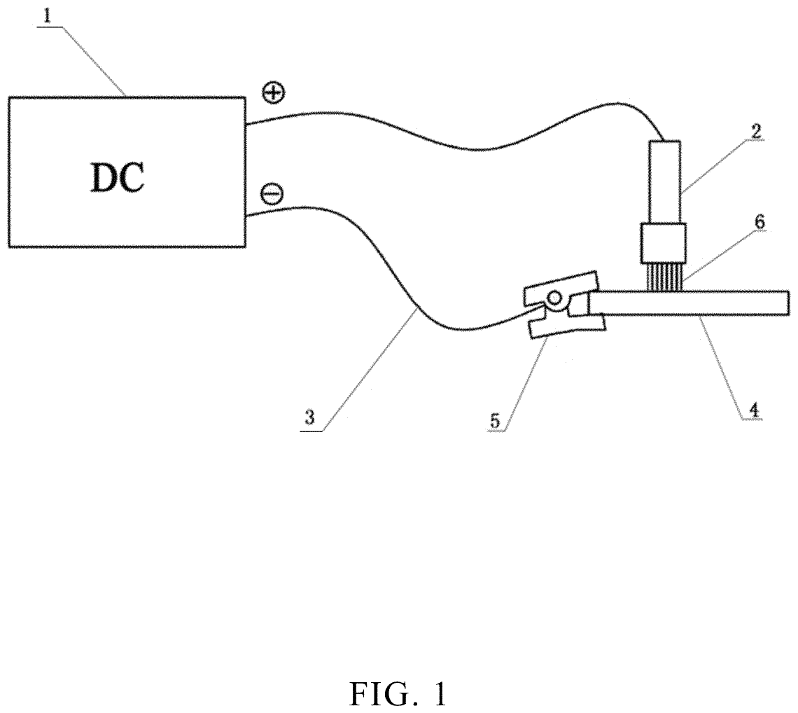

FIG. 2 is a schematic view of a welding bead cleaning device with automatic electrolyte replenishment;

FIG. 3 is a schematic view of a host of a welding bead cleaning device with automatic electrolyte replenishment;

FIG. 4 is a schematic view of a cleaning gun for a welding bead cleaning device with automatic electrolyte replenishment.

### DETAILED DESCRIPTION OF EMBODIMENTS

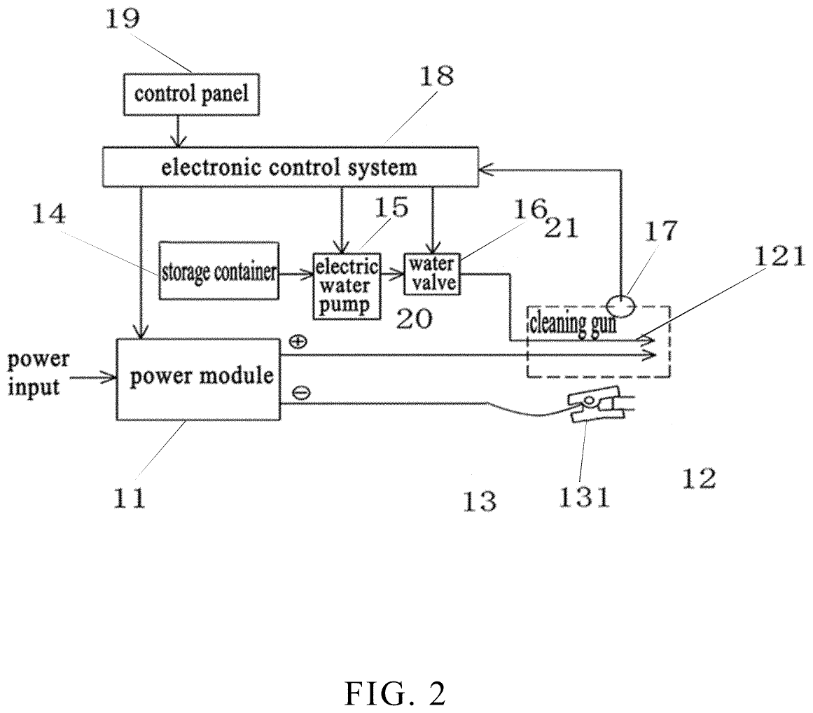

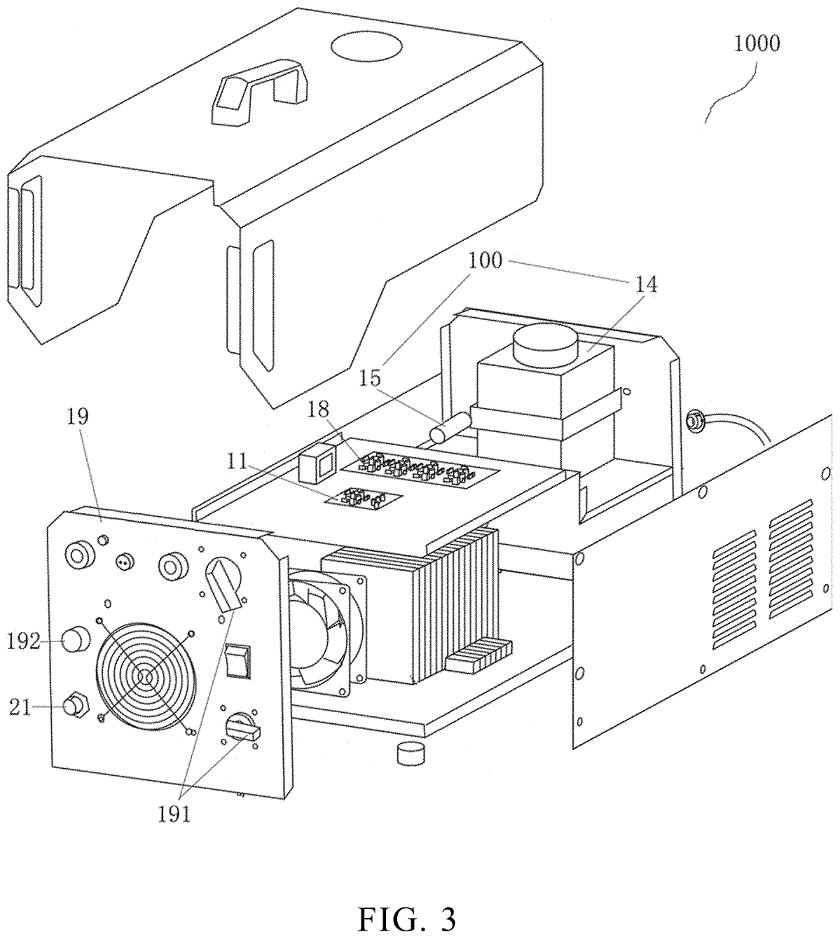

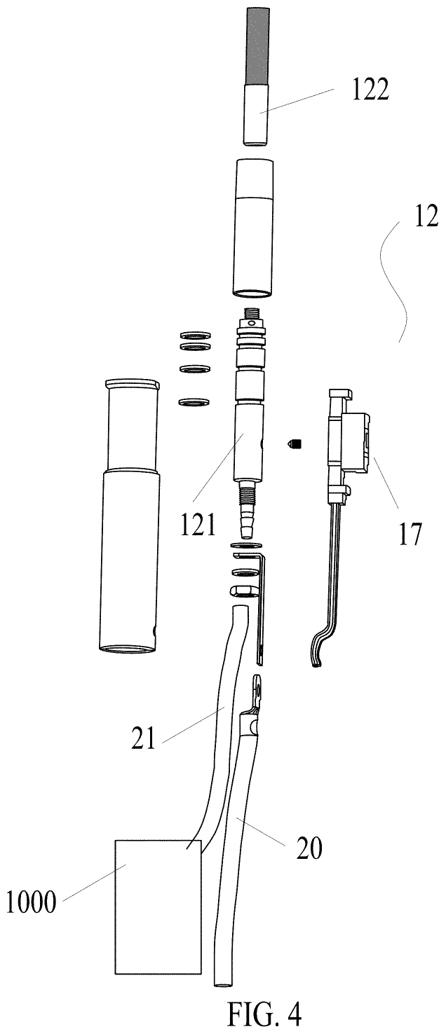

As shown in FIGS. 2-4, the present disclosure provides a welding bead cleaning device with automatic electrolyte replenishment, comprising a host 1000 and a cleaning gun 12. The host 1000 comprises a power module 11, an electrolyte replenishing device 100, and an electronic control system 18.

The power module 11 is connected to a power input such as mains power. The power module 11 is provided with a power output wire 20 and a ground wire 13. The power output wire is connected to the cleaning gun 12. A front end of the ground wire 13 is provided with a ground wire clip 131 for fixing on the workpiece to be cleaned. The cleaning gun 12 contacts the workpiece to be cleaned and an electrolytic circuit is formed.

The cleaning gun 12 is provided with a conductive gun head 121 connected to the power output wire 20, and a flexible structure 122 is provided at a front end of the conductive gun head 121 to absorb the electrolyte for cleaning the welding bead. Preferably, the conductive gun head 121 and the flexible structure 122 are carbon brushes, which not only meet the conductivity requirement, but also have a certain flexibility for cleaning, and the structure of the brush can absorb the electrolyte. Optionally, the conductive gun head 121 may also be a copper head, and the flexible structure 122 is an absorbent cloth or absorbent cotton covered outside the copper head. The gripping part of the cleaning gun 12 is further provided with a control switch 17 connected to the electronic control system 18, which is convenient for the operator to control with one hand.

The electrolyte replenishing device comprises a storage container 14 for storing an electrolyte, the storage container 14 is connected to the conductive gun head 121 through an infusion tube 21, the infusion tube is connected to the electric water pump 15 and the water valve 16, and the electric water pump 15 and the water valve 16 is connected to the electronic control system 18, respectively.

The electronic control system 18 is respectively connected to the power module 11, the electric water pump 15, the water valve 16 and the control switch 17. The electronic control system 18 controls the power output of the cleaning gun 12 through the power module 11. The electronic control system 18 controls the output of the electrolyte through the electric water pump 15 and the water valve 16, and controls the output flow of the electrolyte through controlling the opening degree of the water valve 16. The control switch 17 is used to input a control instruction to the electronic control system 18. When the control switch 17 is triggered, the electronic control system 18 controls the power module 11 and the electric water pump 15 to perform power transmission and liquid delivery, respectively. Further, the electronic control system 18 is provided with a control panel 19 which in turn comprises a power setting key 191 and a flow rate setting key 192, which is convenient for an operator to perform power preset and flow preset.

During the use of the welding bead cleaning device for automatically replenishing the electrolyte, the electronic control system drives the electric water pump and water valve to quantitatively deliver the electrolyte to the cleaning gun, so that the flexible structure like the carbon brushes on the gun can automatically replenish the electrolyte, which eliminates the repeated manual picking action, makes the operation more consistent and improves production efficiency.

The preferred embodiments of the present disclosure are specifically described in conjunction with the above specific structure and size data, but the present disclosure creation is not limited to the described embodiments. Without departing from the spirit of the present disclosure, those skilled in the art can make various equivalent deformations or substitutions which are comprised in the scope defined by the claims of the present application.

1. A welding bead cleaning device with automatic electrolyte replenishment, comprising a host (1000) and a cleaning gun (12), wherein the host (1000) comprises a power module (11), the power module (11) is provided with a power output wire (20) and a ground wire (13), the cleaning gun (12) is provided with a conductive gun head (121) connected to the power output wire, and a front end of the conductive gun head (121) is provided with flexible structure (122) for absorbing an electrolyte for cleaning a welding bead, characterized in that the host (1000) further comprises an electrolyte replenishing device (100) and an electronic control system (18);
the electrolyte replenishing device (100) comprises a storage container (14) for storing an electrolyte and an electric water pump (15), the storage container (14) is connected to the conductive gun head (121) through an infusion tube (21), and the infusion tube (21) is connected to the electric water pump (15); and
the electronic control system (18) is connected to a power module (11) and an electric water pump (15), respectively, and the electronic control system (18) automatically controls the welding bead cleaning device to transmit electricity and deliver electrolyte through the power module (11) and the electric water pump (15).

2. The welding bead cleaning device with automatic electrolyte replenishment according to claim 1, characterized in that the cleaning gun (12) is provided with a control switch (17) which is connected to the electronic control system (18), and when the control switch (17) is triggered, the electronic control system (18) automatically controls the power supply module (11) and the electric water pump (15) to transmit electricity and deliver electrolyte, respectively.

3. The welding bead cleaning device with automatic electrolyte replenishment according to claim 1, characterized in that the infusion tube (21) is further provided with a water valve (16) which is connected to the electronic control system (18), and the electronic control system (18) controls an opening degree of the water valve (16).

4. The welding bead cleaning device with automatic electrolyte replenishment according to claim 1, characterized in that the electronic control system (18) is provided with a control panel (19).

5. The welding bead cleaning device with automatic electrolyte replenishment according to claim 4, characterized in that the control panel (19) is provided with a power setting key (191) and a flow rate setting key (192).

6. The welding bead cleaning device with automatic electrolyte replenishment according to claim 1, characterized in that the conductive gun head (121) and the flexible structure (122) are carbon brushes.

7. The welding bead cleaning device with automatic electrolyte replenishment according to claim 1, characterized in that the conductive gun head (121) is a copper head, and the flexible structure (122) is an absorbent cloth or cotton coated on the copper head.

8. The welding bead cleaning device with automatic electrolyte replenishment according to claim 1, characterized in that a front end of the ground wire (13) is provided with a connection structure (131) for fixing on a workpiece to be cleaned.

9. The welding bead cleaning device with automatic electrolyte replenishment according to claim 8, characterized in that the connection structure (131) is a ground wire clip.
